(19) United States
(12) Patent Application Publication
(10) Pub. No.: US 2006/0175304 A1
(43) Pub. Date: Aug. 10, 2006

(54) Method of forming layers on substrates using microwave energy and apparatus for performing the same

(76) Inventors: Wan-Goo Hwang, Gyeonggi-do (KR); Seung-Ki Chae, Seoul (KR); Myeong-Jin Kim, Gyeonggi-do (KR); Kyoung-Ho Jang, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/346,597

(22) Filed: Feb. 1, 2006

(30) Foreign Application Priority Data
Feb. 1, 2005 (KR) 2005-09179

(51) Int. Cl. B23K 9/00; B23K 9/02

(52) U.S. Cl. 219/121.43

(57) ABSTRACT

In a method and an apparatus for forming layers on substrates, a plurality of substrates is supported by a boat in a processing chamber, and a processing gas is supplied into the processing chamber through a nozzle pipe. The processing gas supplied into processing chamber is excited in plasma state by microwave energy applied through a microwave antenna, and thus layers having uniform thickness may be formed on the substrates by the excited processing gas in the plasma state.

### CROSS REFERENCE TO RELATED APPLICATIONS

This application claims priority from Korean Patent Application No. 10-2005-0009179, which was filed on 1 Feb. 2005. Korean Patent Application No. 10-2005-0009179 is incorporated by reference in its entirety.

### BACKGROUND

1. Technical Field

This disclosure relates to a method and an apparatus for forming layers on substrates and more particularly, to a method and an apparatus for forming a source gas into a plasma and forming layers on substrates, such as silicon wafers, using the plasma.

2. Description of the Related Art

A semiconductor device is manufactured by repeatedly performing a plurality of processes on a semiconductor wafer used as a substrate. For example, a layer formation process forms a layer on the substrate, an oxidation process forms an oxide layer on the substrate or oxidizes the layer formed on the substrate, a photolithography process forms the layer on the substrate into desired patterns, and a planarization process planarizes the layer formed on the substrate.

Various layers may be formed on the substrate by means of a chemical vapor deposition (CVD), a physical vapor deposition (PVD), an atomic layer deposition (ALD), and the like. For example, a silicon oxide layer may be used as a gate insulating layer or an interlayer insulating layer of the semiconductor device and formed using the CVD process. A silicon nitride layer is used as a mask pattern or a gate spacer and formed using the CVD process. Furthermore, a plurality of layers such as a metal layer used as a metal wiring or an electrode, a metal nitride layer used as a barrier layer or an ohmic layer, and the like, may be formed using the CVD process, the PVD process or the ALD process.

For example, a titanium layer and a titanium nitride layer are used as a barrier layer for preventing metal diffusion. The titanium layer is formed by a plasma enhanced chemical vapor deposition (PECVD) process using a source gas comprising titanium and a reducing gas such as a hydrogen gas. The titanium nitride layer is formed by a low pressure chemical deposition (LPCVD) process using a first source gas comprising titanium and a second source gas comprising nitrogen.

A PECVD apparatus of a single substrate type for forming the titanium layer forms the source gas supplied a processing chamber into a plasma by means of applying radio frequency (RF) power to a shower head. A PECVD apparatus of a batch type forms the source gas into the plasma using a remote plasma generator and then supplies the plasma into the processing chamber such as a vertical furnace.

The single substrate type PECVD apparatus, however, has a relatively low throughput. The batch type PECVD apparatus has a relatively high throughput, but thickness uniformity of the layer formed on each substrate is deteriorated because nozzles for supplying the source gas in the plasma state are disposed adjacent to side surfaces of the substrates. In other words, the thickness of the layer formed on the substrate is not uniform throughout the layer. In particular, a central portion of the layer has a thickness that is less than a thickness of an edge portion of the layer.

Embodiments of the invention address these and other disadvantages of the conventional art.

### SUMMARY

According to some embodiments, a batch type layer formation method is capable of improving the thickness uniformity of layers. According to some other embodiments, a batch type layer formation apparatus is capable of improving the thickness uniformity of layers.

### BRIEF DESCRIPTION OF THE DRAWINGS

In the detailed description that follows, exemplary embodiments of the invention are described. The written description of the exemplary embodiments should be considered in conjunction with the accompanying drawings in order to convey the inventive principles of the invention.

FIG. 1 is a sectional diagram illustrating an apparatus for forming layers on substrates according to some embodiments of the invention.

FIG. 2 is a schematic diagram further illustrating the nozzle pipe and gas supply unit of FIG. 1.

FIG. 3 is a sectional diagram further illustrating the microwave antenna of FIG. 1.

FIG. 4 is a perspective diagram further illustrating the nozzle pipe and the microwave antenna of FIG. 1.

FIG. 5 is a plan diagram illustrating another example of the nozzle pipe and the microwave antenna as shown in FIG. 4.

FIG. 6 is a plan diagram illustrating still another example of the nozzle pipe and the microwave antenna as shown in FIG. 4.

FIG. 7 is a plan diagram illustrating still another example of the nozzle pipe and the microwave antenna as shown in FIG. 4.

FIG. 8 is a flow chart illustrating a method of forming layers on substrates according to some embodiments of the invention.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the invention.

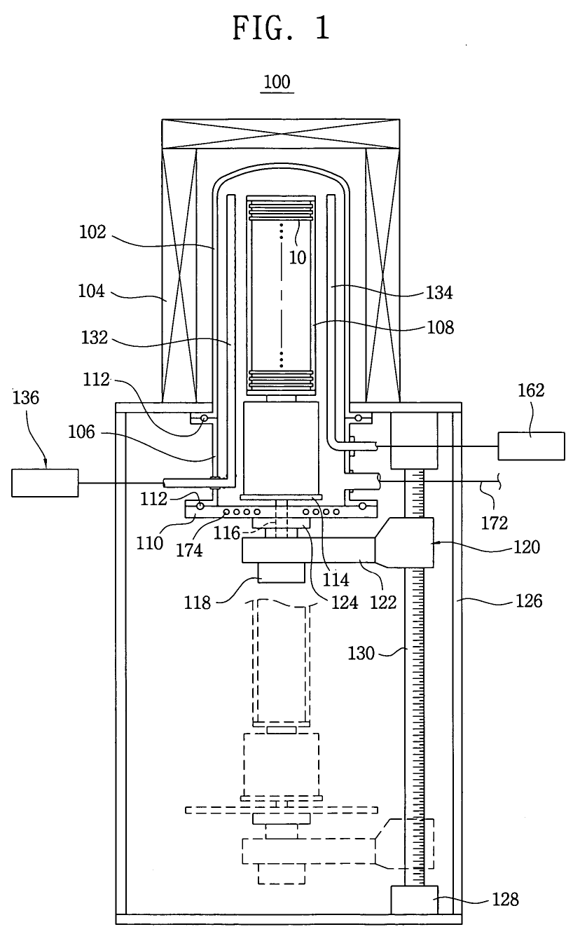

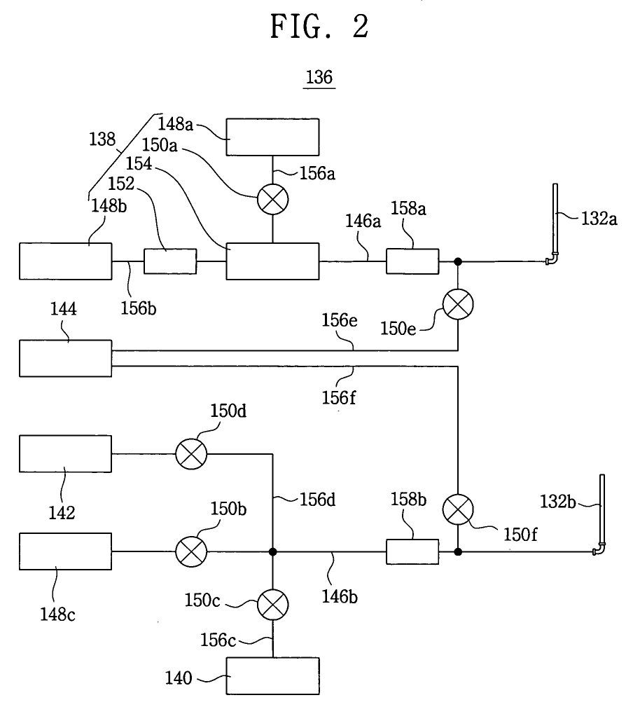

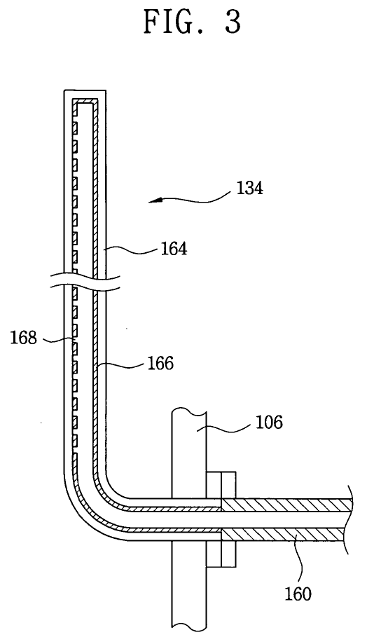

FIG. 1 is a sectional diagram illustrating an apparatus for forming a layer on a substrate according to some embodiments of the invention, FIG. 2 is a schematic diagram further illustrating the nozzle pipe and gas supply unit of FIG. 1 and FIG. 3 is a sectional diagram further illustrating the microwave antenna of FIG. 1.

A layer formation apparatus 100, as shown in FIG. 1, may be employed in a process of forming a layer on a semiconductor substrate 10 such as a silicon wafer. For example, the apparatus 100 may be employed in a chemical vapor deposition process, an atomic layer deposition process, and the like.

Referring to FIG. 1, a processing chamber 102 may include a batch type vertical reaction furnace. Particularly, the processing chamber 102 extends substantially vertically. The processing chamber 102 has a cylindrical shape with an open lower portion and may include quartz. A heating furnace 104 surrounds the processing chamber 102 to heat the processing chamber 102. A cylindrical manifold 106 may be hermetically coupled to the lower portion of the processing chamber 102. The cylindrical manifold 106 may include metal and has open upper and lower ends.

A boat 108 supports a plurality of substrates 10 in multiple stages. In detail, the boat 108 maintains each of the substrates 10 in a horizontal orientation and supports the substrates in a vertical direction at regular intervals. The boat 108 is conveyed into the processing chamber 102 through the lower open end of the manifold 106. The lower open end of the manifold 106 is closed by a lid member 110 after loading the boat 108 into the processing chamber 102. Seal members 112 are interposed between the processing chamber 102 and the manifold 106, and between the manifold 106 and the lid member 112, respectively.

The boat 108 is disposed on a turntable 114 coupled with an upper portion of a rotational shaft 116. A rotational driving unit 118 is mounted on a lower portion of a horizontal arm 122 of a vertical driving unit 120. The lid member 110 is disposed on an upper portion of the horizontal arm 122.

A mechanical seal 124 is disposed between the lid member 110 and the horizontal arm 122 to prevent leakage through a gap between the rotational shaft 116 and the lid member 110. The rotational shaft 116 is connected to the rotational driving unit 118 through the lid member 110, the mechanical seal 124 and the horizontal arm 122.

The manifold 106 is disposed on an upper portion of a load lock chamber 126 or a transfer chamber 126 and the boat 108 is vertically moved between the processing chamber 102 and the load lock chamber 126.

The vertical driving unit 120 may include the horizontal arm 122, a vertical driving section 128 for providing vertical driving force so as to move the horizontal arm 122 vertically and a driving shaft 130 for transmitting the vertical driving force. The vertical driving section 128 may include a first motor, and the driving shaft 130 may include a lead screw to be rotated by the vertical driving force. The horizontal arm 122 is threadably coupled to the driving shaft 130 and vertically moved by rotation of the driving shaft 130.

The rotational driving unit 118 may include a second motor. Particularly, a rotational force provided from the second motor may be transmitted to the rotational shaft 116 through a driving gear connected with the second motor, a driven gear connected with the rotational shaft 116 and a timing belt connecting the driving and driven gears. Alternatively, the driving gear may be directly engaged with the driven gear.

Nozzle pipes 132 for supplying processing gas are disposed between a sidewall of the processing chamber 102 and the boat 108. A microwave antenna 134 is disposed facing the nozzle pipes 132 interposing the boat 108 therebetween in order to apply microwave energy to the processing gas supplied into the processing chamber 102 so that the processing gas is excited in a plasma state.

Referring to FIGS. 1 and 2, a gas supply unit 136 is provided to supply processing gases for forming layers on the substrates 10 placed in the processing chamber 102 and a purge gas for purging an interior of the processing chamber 102.

For example, the gas supply unit 136 may supply a source gas including titanium precursor and hydrogen gas to be used as reducing gas into the processing chamber 102 so as to form titanium layers on the substrates 10. Furthermore, the gas supply unit 136 may supply a first source gas including titanium precursor and a second source gas including nitrogen gas into the processing chamber 102 so as to form titanium nitride layers on the substrates 10.

Particularly, the gas supply unit 136 may include a first gas supply section 138 and a second gas supply section 140 for supplying the source gases, a third gas supply section 142 for supplying the reducing gas and a fourth gas supply section 144 for supplying the purge gas.

The first source gas may include TiCl₄. The first gas may include tetra tertiary butoxy titanium (Ti(OtBu)₄), tetrakis dimethyl amino titanium (TDMAT; Ti(NMe₂)₄), tetrakis diethyl amino titanium (TDEAT; Ti(NEt₂)₄), tetrakis ethyl methyl amino titanium (Ti(NEtMe)₄), and the like. The second source gas may include ammonia (NH₃) gas. The purge gas and carrier gas for carrying the source gases may include argon (Ar) gas or nitrogen (N₂) gas, respectively.

A pair of nozzle pipes 132a and 132b is disposed in the processing chamber 102 and connected to the gas supply unit 136 through the manifold 106. Particularly, the first gas supply section 138 is connected to a lower portion of the first nozzle pipe 132a disposed in the manifold 106 by means of a first gas supply conduit 146a, and the second gas supply section 140 is connected to a lower portion of the second nozzle pipe 132b disposed in the manifold 106 by means of a second gas supply conduit 146b. The first nozzle pipe 132a and the second nozzle pipe 132b have first nozzles and second nozzles formed toward a central axis of the processing chamber 102, respectively.

The first gas supply section 138 includes a first reservoir 148a for providing a first carrier gas, a first valve 150a for adjusting a flow rate of the first carrier gas, a second reservoir 148b for providing a liquid titanium precursor, a liquid mass flow controller 152 for controlling a flow rate of the liquid titanium precursor and a vaporizer 154 for vaporizing the liquid titanium precursor. Alternatively, the first gas supply section 138 may include a bubbler system for vaporizing the liquid titanium precursor.

The first reservoir 148a is connected to the vaporizer 154 by a first connecting conduit 156a, and the first valve 150a is disposed in the first connecting conduit 156a. The second reservoir 148b is connected to the vaporizer 154 by a second connecting conduit 156b, and the liquid mass flow controller 152 is disposed in the second connecting conduit 156b.

The liquid titanium precursor is vaporized in the vaporizer 154, and a gaseous titanium precursor vaporized in the vaporizer 154 and the first carrier gas are supplied into the processing chamber 102 through the first gas supply conduit 146a and the first nozzles of the first nozzle pipe 132a.

The second gas supply section 140 is connected to the second nozzle pipe 132b in order to supply the ammonia gas onto the substrates through the second gas supply conduit 146b. The ammonia gas is used as the second source gas. Particularly, the second gas supply conduit 146b connects the second nozzle pipe 132b with a third reservoir for providing a second carrier gas, and the second gas supply section 140 is connected to the second gas supply conduit 146b by a third connecting conduit 156c. A second valve 150b is disposed in the second gas supply conduit 146b to adjust a flow rate of the second carrier gas, and a third valve 150c is disposed in the third connecting conduit 156c to adjust a flow rate of the second source gas.

The third gas supply section 142 is connected to the second gas supply conduit 146b to supply the reducing gas by a fourth connecting conduit 156d. A fourth valve 150d is disposed in the fourth connecting conduit 156d to adjust a flow rate of the reducing gas.

The fourth gas supply section 144 is connected to the first gas supply conduit 146a and the second gas supply conduit 146b by a fifth connecting conduit 156e and a sixth connecting conduit 156f, respectively. A fifth valve 150e is disposed in the fifth connecting conduit 156e to adjust a flow rate of the purge gas supplied through the first nozzle pipe 132a, and a sixth valve 150f is disposed in the sixth connecting conduit 156f to adjust a flow rate of the purge gas supplied through the second nozzle pipe 132b.

As shown in figures, a first mass flow controller 158a may be disposed in the first gas supply conduit 146a in order to control a flow rate of a first gas mixture of the first source gas and the first carrier gas, and a second mass flow controller 158b may be disposed in the second gas supply conduit 146b in order to control a flow rate of a second gas mixture of the second source gas and the second carrier gas and a flow rate of a third gas mixture of the reducing gas and the second carrier gas.

Referring to FIG. 3, the microwave antenna 134 extends substantially vertically in the processing chamber 102. The microwave antenna 134 is bent to a right angle in the manifold 106, and is then connected to a waveguide 160 for transmitting microwave through a sidewall of the manifold 106. The waveguide 160 is connected to an energy source 162 for providing the microwave energy. The energy source 162 includes a microwave power source for generating microwave. The microwave power source includes an oscillator for generating microwave having a frequency of about 2.45 GHz and an amplifier for amplifying the microwave.

A slot antenna may be used as the microwave antenna 134. The microwave antenna 134 includes a rectangular tube 164 including an insulating material and having an airtight end, and a metal layer 166 formed on inner surfaces of the rectangular tube 164. The insulating material may include quartz, and the metal layer 166 may include copper. The metal layer 166 has a plurality of slots 168 formed toward the central axis of the processing chamber 102 in order to transmit the microwave therethrough. The microwave energy is applied to the processing gases supplied into the processing chamber 102 through the slots 168 and a sidewall of the rectangular tube 164.

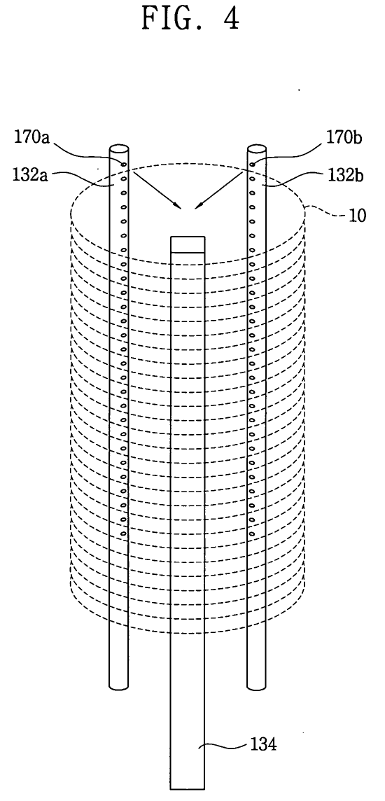

FIG. 4 is a perspective diagram further illustrating the nozzle pipe and the microwave antenna of FIG. 1.

Referring to FIG. 4, the first nozzle pipe 132a is disposed adjacent to the substrates 10 that are loaded in the boat 108 and extends vertically upwardly from the first gas supply conduit 146a. Further, the first nozzle pipe 132a has a plurality of first nozzles 170a for injecting the first source gas. The first nozzles 170a are formed through a sidewall of the first nozzle pipe 132a and spaced at regular intervals along the extension direction of the first nozzle pipe 132a so that the first source gas flows along surfaces of the substrates 10. In other words, the first source gas is injected toward the central axis of the processing chamber 102 through the first nozzles 170a and is then supplied into spaces among the substrates 10.

The second nozzle pipe 132b is disposed adjacent to the substrates 10 loaded in the boat 108 and extends substantially in parallel to the first nozzle pipe 132a from the second gas supply conduit 146b. Further, the second nozzle pipe 132b has a plurality of second nozzles 170b for injecting the second source gas or the reducing gas. The second nozzles 170b are formed through a sidewall of the second nozzle pipe 132b and spaced at regular intervals along the extension direction of the second nozzle pipe 132b so that the second source gas or the reducing gas flows along the surfaces of the substrates 10. In other words, the second source gas or the reducing gas is injected toward the central axis of the processing chamber 102 through the second nozzles 170b and is then supplied into the spaces among the substrates 10.

The first nozzle pipe 132a and the second nozzle pipe 132b are spaced apart at substantially equal intervals from the central axis of the processing chamber 102 and located at an angular interval of about 20° to about 80° in a circumferential direction centering on the central axis of the processing chamber 102.

The source gases supplied into the processing chamber 102 are excited in a plasma state by the microwave energy applied from the microwave antenna 134. Accordingly, because the source gases are formed in the plasma state in the processing chamber 102, layers having a uniform thickness may be formed on the substrates 10.

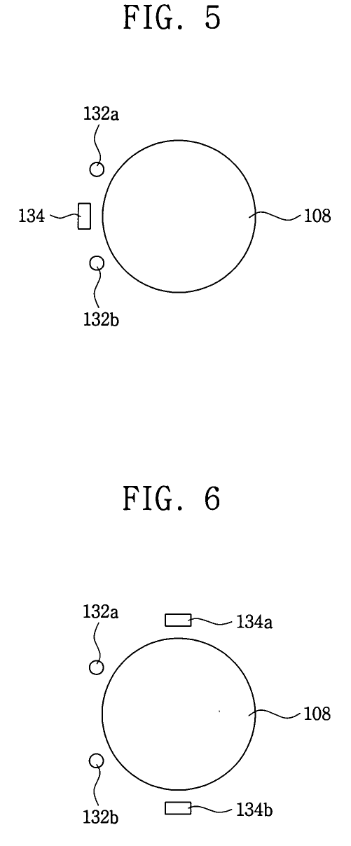

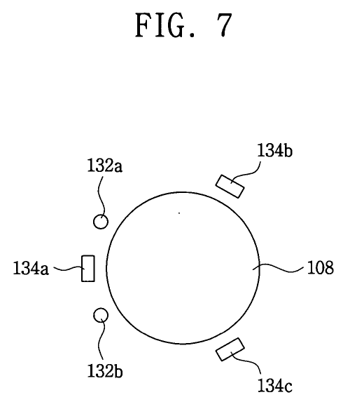

As shown in FIG. 4, one microwave antenna 134 is disposed opposite to the first and second nozzle pipes 132a and 132b. However, one microwave antenna 134 may be disposed between the first and second nozzle pipes 132a and 132b, as shown in FIG. 5. Further, as shown in FIGS. 6 and 7, a pair of microwave antennas 134a and 134b is disposed opposite to each other with the boat 108 interposed therebetween, and a plurality of microwave antennas 134a, 134b and 134c is radially disposed centering on the boat 108.

Referring again to FIG. 1, a vacuum pump (not shown) is connected to the manifold 106 to evacuate the processing chamber 102 through a vacuum conduit 172 and an isolation valve (not shown), and the heating furnace 104 is disposed adjacent to the sidewall and a ceiling of the processing chamber 102.

The temperature in the interior of the manifold 106 may be less than that of the processing chamber 102. To compensate for such a temperature difference, a heater 174 is disposed within the interior of the lid member 110. That is, the heater 174 heats the interior of the manifold 106 so that temperature distribution is uniformly maintained in the processing chamber 102 and the manifold 106. The heater 174 may include an electrical resistance heating wire. Alternatively, the heater 174 may be embedded within the sidewall of the manifold 106 or disposed on an inner surface of the manifold 106.

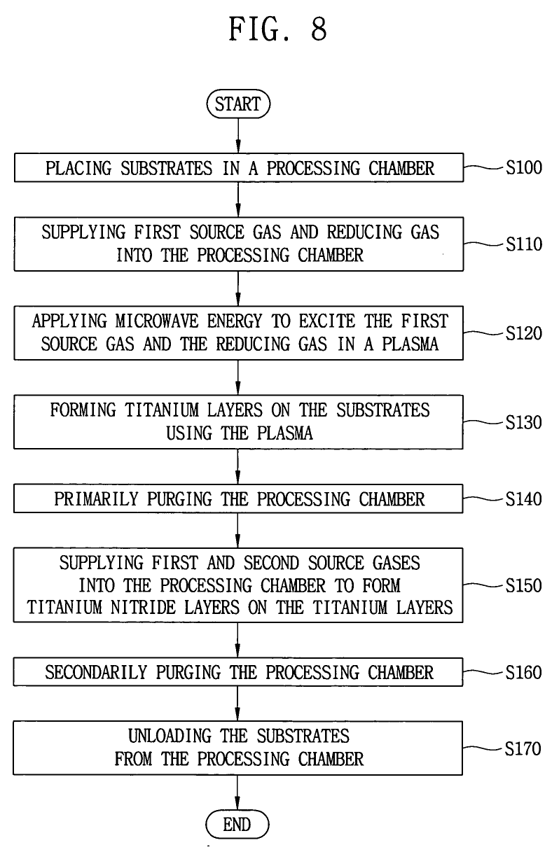

FIG. 8 is a flow chart illustrating a method of forming layers on substrates according to some embodiments of the invention.

A method of forming titanium layers and titanium nitride layers on the substrates 10 are described in detail below with reference to the accompanying drawings. The titanium layer may be used as an ohmic contact, and the titanium nitride layer may be used as a metal barrier layer.

In process S100, the substrates 10 are placed in the processing chamber 102. Particularly, the substrates 10 are loaded vertically at equally spaced intervals in the boat 108, and each substrate 10 is maintained in a horizontal direction. The boat 108 is transferred into the processing chamber 102 through the manifold 106 by means of operation of the vertical driving unit 120.

Semiconductor structures may be formed on the substrates 10. For example, each of the semiconductor structures may include a transistor, a lower electrode and a dielectric layer of a capacitor. The transistor includes a gate structure and impurity regions used as source/drain regions, and the lower electrode is connected to one of the impurity regions. The dielectric layer is formed on the lower electrode of the capacitor. The lower electrode may include impurity doped polysilicon, and the dielectric layer may include hafnium oxide (HfO₂).

In process S110, the first source gas and the reducing gas are supplied into processing chamber 102 through the first nozzles 170a and the second nozzles 170b, respectively. The first source gas includes TiCl₄, and the reducing gas includes hydrogen (H₂).

In process S120, the first source gas and the reducing gas are excited in the plasma state in the processing chamber 102 by applying the microwave energy. Preferably, the microwave energy has a frequency of about 2.45 GHz and is applied to the first source gas and the reducing gas through the microwave antenna 134 disposed in the processing chamber 102.

In process S130, the titanium layers are formed on the substrates 10 using the plasma gas, respectively.

In process S140, after forming the titanium layers, the purge gas is supplied into the processing chamber 102 so that the interior of the processing chamber 102 is primarily purged.

In process S150, the first and second source gases are each supplied into the processing chamber 102 through the first and second nozzles 170a and 170b so that the titanium nitride layers are formed in-situ on the titanium layers. The first source gas may include TiCl₄, and the second source gas may include NH₃.

In process S160, after formation of the titanium nitride layers having a desired thickness, the purge gas is supplied into the processing chamber 102 so that the interior of the processing chamber 102 is secondarily purged.

In process S170, the substrates 10 are unloaded from the processing chamber 102. The boat 108 is transferred from the processing chamber 102 to the load lock chamber 126.

According to exemplary embodiments of the invention, layers having a uniform thickness may be formed by applying the microwave energy to the gases that are present in the processing chamber.

Furthermore, the layer formation apparatus can perform in-situ the plasma enhanced chemical vapor deposition using the microwave energy and the low pressure chemical vapor deposition. That is, after forming the titanium layers using the layer formation apparatus, the titanium nitride layers may be subsequently formed in the in-situ manner.

The invention may be practiced in many ways. What follows are exemplary, non-limiting descriptions of some embodiments of the invention.

According to some embodiments, a plurality of substrates is placed in a processing chamber, and a processing gas is supplied into the processing chamber. The supplied processing gas is excited into a plasma state by applying microwave energy, and then the layers are formed by reaction between the excited processing gas and surfaces of the substrate.

According to some embodiments, an apparatus for forming layers of substrates includes a processing chamber, a boat for supporting the substrates in the processing chamber in multiple stages, at least one nozzle pipe for supplying a processing gas into the processing chamber so as to form the layers on the substrates, the at least one nozzle pipe extending substantially vertically in the processing chamber, and at least one microwave antenna for applying microwave energy to the processing gas supplied into the processing chamber so as to form the supplied processing gas into a plasma state, the at least one microwave antenna extending substantially in parallel to the at least one nozzle pipe.

According to embodiments of the invention, the layers on the substrates are formed to have a uniform thickness throughout because the processing gas is formed into the plasma in the processing chamber.

While exemplary embodiments of the invention and some of their advantages were described in detail above, it should be understood that various changes, substitutions and alterations may be made to those exemplary embodiments without departing from one or more of the inventive principles that the exemplary embodiments possess, and which are defined by the attached claims.

1. A method of forming layers on substrates, the method comprising:
placing substrates inside a processing chamber;
supplying a processing gas inside the processing chamber; and
applying microwave energy to the processing gas to excite the processing gas to a plasma state and to form the layers on the substrates.

2. The method of claim 1, wherein supplying the processing gas comprises supplying a titanium (Ti) precursor.

3. The method of claim 2, wherein supplying the processing gas comprises supplying one or more selected from the group consisting of TiCl₄, Ti(OtBu)₄, Ti(NMe₂)₄, Ti(NEt₂)₄, and Ti(NEtMe)₄.

4. The method of claim 1, wherein supplying the processing gas comprises supplying titanium tetrachloride (TiCl₄) and hydrogen (H₂).

5. The method of claim 4, wherein supplying the titanium tetrachloride (TiCl₄) and the hydrogen (H₂) comprises:
supplying the titanium tetrachloride (TiCl₄) to the inside of the processing chamber through a first nozzle; and
supplying the hydrogen (H₂) to the inside of the processing chamber through a second nozzle.

6. The method of claim 1, wherein applying microwave energy to form the layers comprises applying microwave energy to form titanium layers.

7. The method of claim 6, further comprising forming titanium nitride layers in-situ on the titanium layers.

8. An apparatus for forming layers on substrates, the apparatus comprising:
a processing chamber;
a boat structured to support the substrates inside the processing chamber in multiple stages;
a first nozzle pipe structured to supply a first processing gas into the processing chamber, the first nozzle pipe extending substantially vertically in the processing chamber; and
a first microwave antenna structured to apply microwave energy to the processing gas to bring the processing gas to a plasma state and to form the layers on the substrates, the first microwave antenna arranged substantially parallel to the first nozzle pipe.

9. The apparatus of claim 8, wherein the processing chamber has a substantially cylindrical shape, a closed upper portion, and an open lower portion, and is disposed such that a long axis of the substantially cylindrical shape extends in a vertical direction.

10. The apparatus of claim 9, further comprising:
a first heater structured to regulate a processing temperature inside the processing chamber, the first heater surrounding the processing chamber;
a cylindrical manifold coupled to the open lower portion of the processing chamber, the cylindrical manifold having an open upper end and an open lower end; and
a vertical driving unit structured to insert the boat into the processing chamber through the manifold and structured to remove the boat from the processing chamber through the manifold.

11. The apparatus of claim 10, wherein the vertical driving unit comprises:
a first motor structured to provide a first rotational force;
a lead screw structured to rotate in response to the first rotational force; and
a horizontal arm threadably coupled to the lead screw and structured to move vertically in response to a rotation of the lead screw.

12. The apparatus of claim 11, further comprising:
a lid member disposed on the horizontal arm, the lid member structured to open and close the open lower end of the manifold;
a turntable disposed on the lid member, the turntable structured to support the boat; and
a rotational driving unit connected to the turntable, the rotational driving unit structured to rotate the boat.

13. The apparatus of claim 12, wherein the rotational driving unit comprises:
a second motor mounted on the horizontal arm, the second motor structured to provide a second rotational force to rotate the boat; and
a rotational shaft structured to connect the second motor with the turntable through the horizontal arm and the lid member, the rotational shaft structured to transmit the second rotational force to the turntable.

14. The apparatus of claim 10, further comprising a second heater structured to regulate a temperature within the manifold.

15. The apparatus of claim 8, wherein the first microwave antenna and the first nozzle pipe are arranged opposite to each other in the processing chamber, and the boat is positioned between the first microwave antenna and the first nozzle pipe when the boat is inside the processing chamber.

16. The apparatus of claim 8, further comprising a second nozzle pipe, wherein the first nozzle pipe and the second nozzle pipe are disposed between the boat and a sidewall of the processing chamber, and the second nozzle pipe is structured to supply a second processing gas different from the first processing gas into the processing chamber.

17. The apparatus of claim 16, wherein the first microwave antenna is disposed between the first nozzle pipe and the second nozzle pipe.

18. The apparatus of claim 8, further comprising a second microwave antenna, wherein the first and second microwave antennas are disposed opposite to each other in the processing chamber, and the boat is positioned between the first and second microwave antennas when the boat is inside the processing chamber.

19. The apparatus of claim 8, further comprising a plurality of microwave antennas disposed radially around the boat.

20. The apparatus of claim 8, wherein the first microwave antenna comprises a slot antenna.

21. The apparatus of claim 20, wherein the slot antenna comprises:
an airtight rectangular tube comprising an insulating material; and
a metal layer disposed on inner surfaces of the airtight rectangular tube, the airtight rectangular tube having a plurality of slots configured to transmit microwave energy.

22. The apparatus of claim 8, further comprising:
a waveguide connected to the first microwave antenna and structured to transmit a microwave; and
an energy source structured to generate the microwave.
